(19) United States
(12) Patent Application Publication
(10) Pub. No.: US 2007/0177503 A1
(43) Pub. Date: Aug. 2, 2007

(54) Call admission to a wireless network based on application-specific quality of service information

(76) Inventors: Christopher Francis Mooney, Livingston, NJ (US); David Albert Rossetti, Randolph, NJ (US); Jialin Zou, Randolph, NJ (US)

Correspondence Address: WILLIAMS, MORGAN & AMERSON, 10333 RICHMOND, SUITE 1100, HOUSTON, TX, 77042, US

(21) Appl. No.: 11/343,769

(22) Filed: Jan. 31, 2006

(51) Int. Cl. H04L 12/26; H04L 12/56

(52) U.S. Cl. 370/230; 370/395.21

(57) ABSTRACT

The present invention provides a method of call admission to a wireless network. The method may include accessing quality of service information associated with a voice application associated with an access terminal in response to receiving a call session request from the access terminal. The method may also include determining whether to admit the requested call session based on the quality of service information associated with the voice application.

### BACKGROUND OF THE INVENTION

1. Field of the Invention

This invention relates generally to communication systems, and, more particularly, to wireless communication systems.

2. Description of the Related Art

Conventional wireless communication systems include one or more access networks, which may also be referred to as node-Bs, base stations, and base station routers, for providing wireless connectivity to one or more access terminals, which may also be referred to using terms such as user equipment, subscriber equipment, and mobile units. Exemplary access terminals include cellular telephones, personal data assistants, smart phones, text messaging devices, laptop computers, desktop computers, and the like. An access network may provide wireless connectivity concurrently to one or more access terminals, such as the access terminals in a geographical area, or cell, associated with the access network. Each access network has a limited budget of radio resources that may be used to provide a wireless connectivity. Exemplary radio resources include total transmission power, available channel codes, time slots, modulation/coding sets, backhaul resources to a core network, and the like.

When an access terminal attempts to initiate a call session with an access network, the access network determines whether or not to admit the call based in part on the radio resource budget. For example, the access network may execute a Call Admission algorithm to determine whether or not a request to establish a call session can be accepted. If the request is accepted a new call session may be established between the access terminal and the access network. If not, then the call is blocked and is given a call denial treatment. For example, a call session request may be denied when there are insufficient network resources to maintain the new call without causing another existing call to drop or increasing the probability that an existing call may be dropped above a predetermined level. The voice capacity of a wireless network is typically expressed in units of erlangs based upon some blocking rate. One goal of the call admission algorithm is to maximize the number of calls accepted by the wireless voice network for a given level of call blocking.

Conventional call admission algorithms implemented in packet-based networks consider the quality of service requirements associated with each access terminal that has an active call session. For example, the call admission algorithm may determine a traffic load associated with each access terminal using an assumed voice activity factor for each access terminal. The voice activity factor may be defined as the percentage of time that speech is transported in a given direction of a call. For example, during a two-way conversational full-duplex voice call one party is speaking while the other party is listening, so the voice activity factor is approximately 50%. In practice, the voice activity factor is typically slightly less than 50% due to human factors. The call admission algorithm cannot determine what the actual voice activity factor for the requested call will be, so conventional call admission algorithms simply assume that the voice activity factor associated with the access terminal will be slightly less than 50%.

A single access terminal may, however, be capable of running numerous voice applications that may not all have a voice activity factor of approximately 50%. For example, a Push-to-Talk application may allow a single access terminal to establish a voice call with numerous other access terminals. Thus, the voice activity factor associated with the access terminal may be much less than 50%. For example, if the access terminal establishes a call session with three other access terminals, the voice activity factor for each access terminal on the reverse link may be closer to 25% and the voice activity factor on the forward link may be approximately 75%. If the actual voice activity factor of a given call is higher than the estimated voice activity factor used for call admission, overly optimistic system loading will be applied by the call admission algorithm, which may allow calls to be admitted when there is insufficient capacity to support the total set of active calls. Thus, the service of one or more calls could fail to meet the committed quality of service requirements and in some cases an active call could be dropped. If the actual voice activity factor of a given call is lower than the estimated voice activity factor used for call admission, then resource usage may be inefficient and the maximum capacity of the system may not be reached.

Conventional call admission algorithms may also determine the traffic load associated with each access terminal using an assumed (or default) average data rate of a vocoder in the access terminal. For example, the call admission algorithm may assume that the access terminal is using a full-rate Enhanced Variable Rate Coder (EVRC) vocoder that has a typical average data rate of approximately 9.6 kilobit per second (kbps). However, the actual rate of the vocoder may differ from the assumed (or default) or may change during operation of the access terminal. For example, the access terminal may be using (or may change to) a half-rate EVRC vocoder that has a typical average data rate of approximately 4.8 kbps. If the actual average data rate of a given call is higher than the assumed average data rate used for call admission, overly optimistic system loading will be applied by the call admission algorithm, which may allow calls to be admitted when there is insufficient capacity to support the total set of active calls. Thus, the service of one or more calls could fail to meet the committed quality of service requirements and in some cases an active call could be dropped. If the actual average data rate of a given call is lower than the assumed average data rate used for call admission, then resource usage may be inefficient and the maximum capacity of the system may not be reached.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for call admission to a wireless network. The method may include accessing quality of service information associated with a voice application associated with an access terminal in response to receiving a call session request from the access terminal. The method may also include determining whether to admit the requested call session based on the quality of service information associated with the voice application.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates one exemplary embodiment of an access terminal and an access network, in accordance with the present invention;

FIG. 3 conceptually illustrates one exemplary embodiment of a method of admitting or denying call session requests, in accordance with the present invention;

FIG. 4 conceptually illustrates one exemplary embodiment of a method of handling call session requests and modifying the source rate of an application based on a grade of service, in accordance with the present invention; and

FIG. 5 conceptually illustrates one exemplary embodiment of a method of modifying the source rate of an application when system loading changes based on a grade of service, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

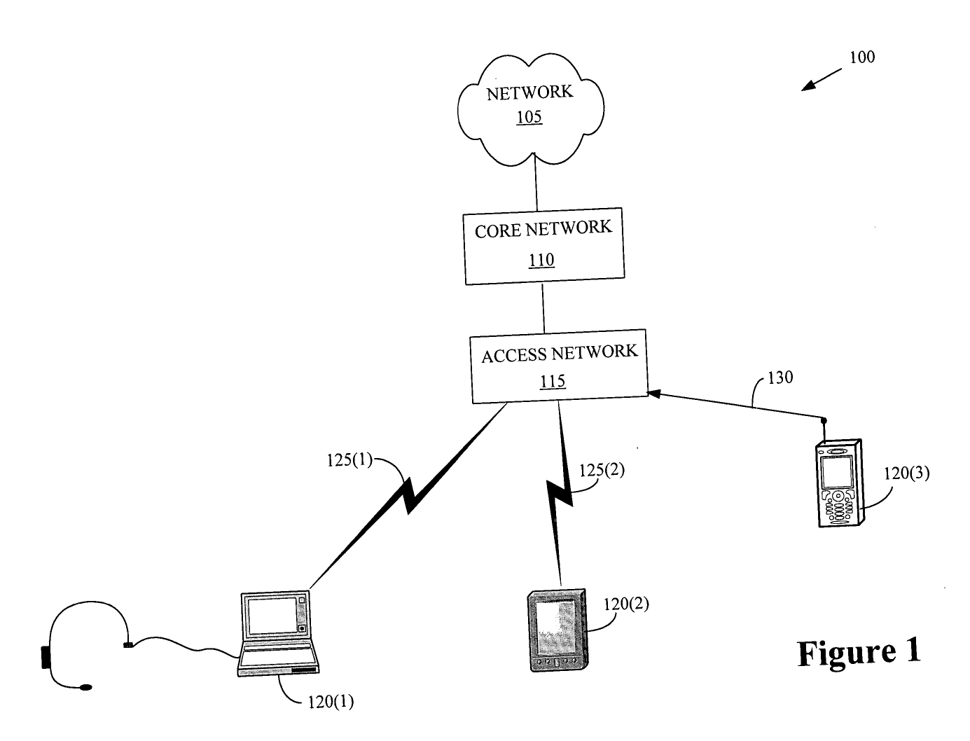

FIG. 1 conceptually illustrates one exemplary embodiment of a wireless communication system 100. In the illustrated embodiment, the wireless communication system 100 operates according to one or more air interface standards and/or protocols, such as the CDMA2000 Evolution-Data Optimized (EVDO) and Universal Mobile Telecommunication Services (UMTS) standards defined by the Third Generation Partnership Project (3GPP2, 3GPP). However, persons of ordinary skill in the art should appreciate that the present invention is not limited to a wireless communication system 100 that operates according to these particular standards and/or protocols. In alternative embodiments, the wireless communication system 100 may operate according to any wired and/or wireless standard and/or protocol. The wireless communication system 100 also includes a network 105 that may operate according to an Internet Protocol (IP), as well as one or more of the standards and/or protocols described above. For example, the network 105 may be a public Internet and/or a private Intranet.

The network 105 may be communicatively coupled to one or more core networks 110 and one or more access networks 115. For example, a standard CDMA2000 EVDO network environment includes one or more Gateway General Packet Radio Service (GPRS) Support Nodes (GGSNs), Serving GPRS Support Nodes (SGSNs), Radio Network Controllers (RNCs) and Node-Bs. The GGSNs and SGSNs are typically considered part of the wireless core network 110. The RNC and the Node-Bs typically form the access network 115, which may also be referred to as a Radio Access Network (RAN). The GGSN, SGSN and portions of the RNC may provide IP tunneling functionality and macro-mobility. The RNCs and Node-Bs may provide for wireless transmission and reception functionality and micro-mobility functionality. However, persons of ordinary skill in the art should appreciate that the present invention is not limited to embodiments that include a core network 110 and an access network 115. In alternative embodiments, wireless connectivity may be provided by other devices such as base stations, base station routers, and the like.

The access network 115 provides wireless connectivity to one or more access terminals 120(1-3). In the interest of clarity, the indices (1-3) may hereinafter be dropped when the access terminals 120 are being referred to collectively. However, the indices (1-3) may be used when referring to the access terminals 120 individually or to a subset of the access terminals 120. The same convention may be used with regard to other indices that distinguish between components that share an identifying numeral. Exemplary access terminals may include laptop computers 120(1), smart phones 120(2), and mobile phones 120(3), as well as other devices not shown in FIG. 1 such as personal data assistants, desktop computers, paging devices, network interface cards, and the like. Persons of ordinary skill in the art having benefit of the present disclosure should appreciate that the access terminals 120 may also be referred to using other terms such as “mobile units,” “user terminals,” “user equipment,” “mobile terminals,” and the like.

In the illustrated embodiment, two access terminals 120(1-2) have established communication links to the access network 115 over air interfaces 125(1-2), which may support one or more traffic, data, and/or signaling channels over a forward link (or downlink) and/or a reverse link (or uplink). However, persons of ordinary skill in the art should appreciate that the present invention is not limited to two access terminals 120(1-2) or two air interfaces 125. In alternative embodiments, any number of access terminals 120 (or none) may communicate with the access network 115 using any number of air interfaces 125 (or none). Furthermore, the number of access terminals 120 in communication with the access network 115 may vary over time. The access terminals 120(1-2) may use the air interfaces 125(1-2) to transmit and/or receive voice information. For example, the access terminal 120(1) may implement a Voice over IP (VoIP) application for transmitting and/or receiving voice information over the air interface 125(1). For another example, the access terminal 120(2) may implement a wireless telephone application for transmitting and/or receiving voice information over the air interface 125(1).

The access terminal 120(3) may provide a call session request to the access network 115, as indicated by the arrow 130. For example, a user of the access terminal 120(3) may want to initiate a call session to establish voice communication with a user of another access terminal (not shown) that is communicatively coupled to the network 105. The call session request may be provided by a voice application implemented on the access terminal 120(3). As used herein, the term “voice application” refers to hardware, firmware, software, or a combination thereof that is used to implement a particular technique for accessing the wireless communication system 100 so that voice information be transmitted to and/or received from the wireless communication system 100. Exemplary voice applications include, but are not limited to, cellular telephone applications for implementing two-way full-duplex voice calls and/or two-way half-duplex voice calls, as well as Push-to-Talk applications, VoIP applications, a three-way calling applications, a chat room application, a conference bridge call application, and the like. Persons of ordinary skill in the art having benefit of the present disclosure should appreciate that voice information may include information indicative of sounds made by a user of the access terminal 120(3), as well as any other sounds, noise, or other acoustic signals that may be associated with the sounds made by the user. For example, voice information may include information indicative of ambient noise present in the environment near the user and/or “comfort noise” provided by the voice application when no sounds (or acoustic signals below a predetermined threshold) are being provided by the user and/or the user's environment.

The access network 115 may then determine whether or not to admit the requested call session. In one embodiment, the access network 115 may implement a call admission algorithm to determine whether or not to admit the requested call session based on the quality of service information associated with the voice application. As used herein, the phrase “quality of service information” will be understood to refer to information indicative of some aspect of the quality of service that may be associated with the requested call session. In one embodiment, the quality of service information includes a voice activity factor associated with the voice application. The quality of service information may also include an average data rate associated with a vocoder used by the voice application. For example, vocoders may support multiple operating points throughout a range of average data rates and the voice application may utilize any one of the supported average data rates. The quality of service information may also include a grade of service provided by the voice application and/or the wireless communication system 100. For example, the voice application may provide “Premium,” “Basic,” and “Budget” grades of service.

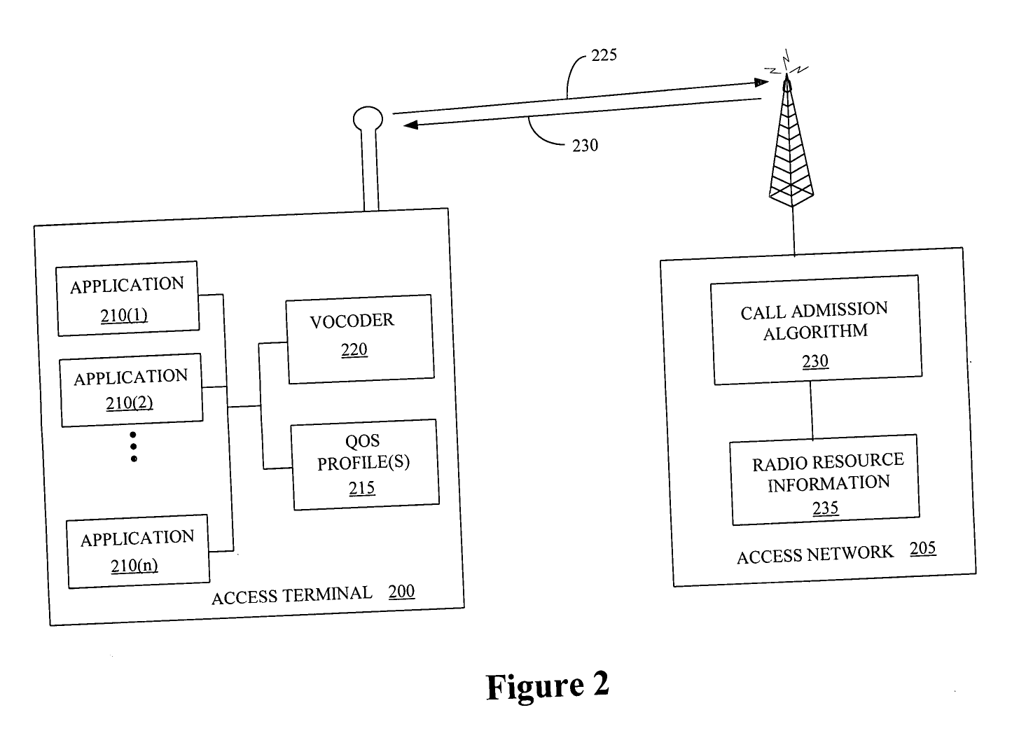

FIG. 2 conceptually illustrates one exemplary embodiment of an access terminal 200 and an access network 205. In the illustrated embodiment, the access terminal 200 includes one or more voice applications 210 that may be used to transmit and/or receive voice information. Exemplary voice applications 210 include, but are not limited to, applications for establishing two-way full-duplex voice calls and/or two-way half-duplex voice calls, a Push-to-Talk call application, a VoIP call application, a three-way call application, a chat room application, a conference bridge call application, and the like. Depending on the circumstances, one or more of the voice applications 210 may be used to support one or more voice flows associated with one or more users of the access terminal 200. Quality of service information may therefore be associated with each of the voice applications 210, as well as the voice flows and/or users associated with the voice applications 210. The voice applications 210 may also provide one or more services at different grades, each of which may have different associated quality of service information.

In the illustrated embodiment, the quality of service information associated with the voice applications 210, the voice flows, and/or the users may be stored in one or more quality of service (QoS) profiles 215. For example, the access terminal 200 may include one or more memory elements for storing the quality of service profiles 215. The voice applications 210 may access the quality of service profiles 215 to determine the quality of service information associated with the voice applications 210 the voice flows, and/or the users. For example, in a High Rate Packet Data (HRPD) (IS-856) wireless network, a quality of service profile identifier or QoS BLOB could be used to specify a range of voice activity factors associated with the voice applications 210 the voice flows, and/or the users. Alternatively, new per-flow attributes could be defined that would specify the expected data needs of call reservations on a forward link and/or a reverse link. These attributes could be negotiated between the access terminal client application 210 and the access network.

The access terminal includes a vocoder 220 for encoding and/or decoding the voice information provided by, or received by, the voice applications 210. The vocoder 220 may support more than one average data rate. Furthermore, the average data rates supported by the vocoder 220 may be different for the different voice applications 210. For example the vocoder 220 may support an average data rate of approximately 9.6 kbps when operating in a full-rate mode and an average data rate of approximately 4.8 kbps when operating in a half-rate mode. The voice applications 210 may access information indicative of the average data rate associated with a vocoder 220. For example, the voice applications 210 may access information indicative of the average data rate associated with the vocoder 220 from one or more registers and/or memory elements (not shown) associated with the vocoder 220. In one embodiment, the access network 205 could dynamically adjust the voice activity factor or the output rate of the vocoder 220 by updating and sending the attribute to the access terminal at a per flow basis as indicated by arrow 230. In one embodiment, the available rate options and/or operation points of the application (e.g., voice with a particular type of vocoder) may be included in the QoS profile of this application. The profile may be identified by an unique profile ID.

The access terminal 220 may provide a call admission request to the access network 205, as indicated by the arrow 225. In the illustrated embodiment, the call admission request may include information indicative of quality of service information associated with the voice application 210 that provided the call admission request. For example, a user may invoke the voice application 210(1) to establish a call session with the access network 205. The voice application 210(1) may access a quality of service profile 215 to determine a voice activity factor associated with the voice application 210(1) and may then provide information indicative of the voice activity factor as a part of the call admission request 225. For another example, the voice application 210(1) may determine an average data rate associated with the vocoder 220 for the requested call and may provide information indicative of the average data rate as a part of the call admission request 225.

The access network 205 implements a call admission algorithm 230. Persons of ordinary skill in the art having benefit of the present disclosure should appreciate that the call admission algorithm 230 may be implemented in hardware, firmware, software, or any combination thereof. For example, the call admission algorithm 230 may be implemented in software that may be executed by a processor (not shown) included in the access network 200. Furthermore, as discussed above, the access network 205 may be a part of an access network and so portions of the call admission algorithm 230 may be implemented in other parts of the access network.

The call admission algorithm 230 may then determine whether or not to admit the call requested by the access terminal 200 based on the quality of service information associated with the voice application 210(1). For example, the call admission algorithm 230 could decide whether to allow or block the requested call by using a profile ID or QoS characteristic provided by the voice application 210(1) to estimate a system load associated with the requested call and/or any existing call sessions. If the voice application 210(1) provided voice activity factor information for a 4-way voice call, then the call admission algorithm 230 may use a 25% reverse link and a 75% forward link voice activity factor for the 4-way voice call rather than using a 50% voice activity factor for all voice calls. For another example, the call admission algorithm 230 may determine whether or not to admit the requested call based on a 4.8 kbps average data rate instead of an average data rate of 9.6 kbps if the call admission request indicates that the vocoder 220 is operating in a half-rate mode instead of a full-rate mode. For yet another example, the call admission algorithm 230 may determine whether or not to admit the requested call based upon a grade of service associated with the requested call.

The call admission algorithm 230 may also determine whether or not to admit the call requested by the access terminal 200 based on one or more available radio resources. Exemplary radio resources may include overall system capacity and/or loading, total transmission power, available channel codes, time slots, modulation/coding sets, backhaul resources to a core network, and the like. In the illustrated embodiment, the access network 205 stores the radio resource information 235 so that the call admission algorithm 230 may access the radio resource information 235. For example, the radio resource information 235 may be stored in one or more memory elements resident on the access network 205. However, persons of ordinary skill in the art having benefit of the present disclosure should appreciate that some or all of the radio resource information may not be stored on the access network 205, but may instead be stored at another location and accessed by the access network 205.

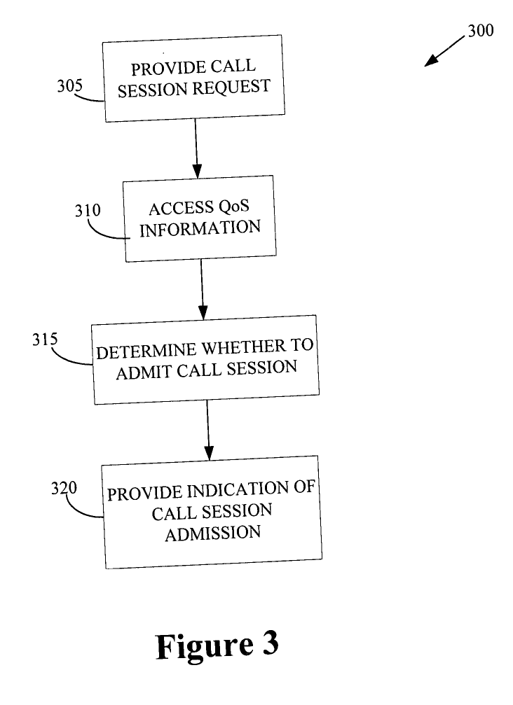

FIG. 3 conceptually illustrates one exemplary embodiment of a method 300 of admitting or denying call session requests. In the illustrated embodiment, a call session request is provided (at 305) by an access terminal to an access network. The access network then accesses (at 310) quality of service information associated with the voice application on the access terminal that provided (at 305) the call session request. For example, the access network accesses (at 310) quality of service information that was provided by the voice application in the call admission request provided (at 305) by the access terminal. The access network then determine (at 310) whether or not to admit the call session based on the quality of service information associated with the voice application. In some embodiments, the access network may also determine (at 310) whether or not to admit the requested call session based on other radio resources associated with the wireless communication system. The access network may provide (at 315) an indication of whether or not the requested call session has been admitted and, if the requested call session has been admitted, a new call session may be established between the access terminal and the access network.

One more embodiments of the techniques described above may have the number of advantages over conventional practice. Determining whether or not to admit a requested call session based upon a quality of service requirements such as a voice activity factor may allow a wireless communication system to make a more accurate determination of whether or not the network can support the requested call. For example, the actual voice activity factor of a given call on a given forward and/or reverse link may be significantly different than the conventional estimate of approximately 50%. Accordingly, determining whether or not to admit the requested call based on the actual voice activity factor of the call (or the forward and/or reverse link) may reduce or prevent overly optimistic or pessimistic system loading calculations, which may lead to overloading or inefficient usage of the system resources, respectively. Moreover, variable grades of service may be supported more efficiently by allowing the access network to adjust the assumed voice activity factor of each access terminal on a per user/voice flow basis. For example, the voice activity factor of each user can be adjusted based on the system loading and the grade of service requirements of different users to take advantage of available system resources while ensuring that the highest grade of service is provided to premium users.

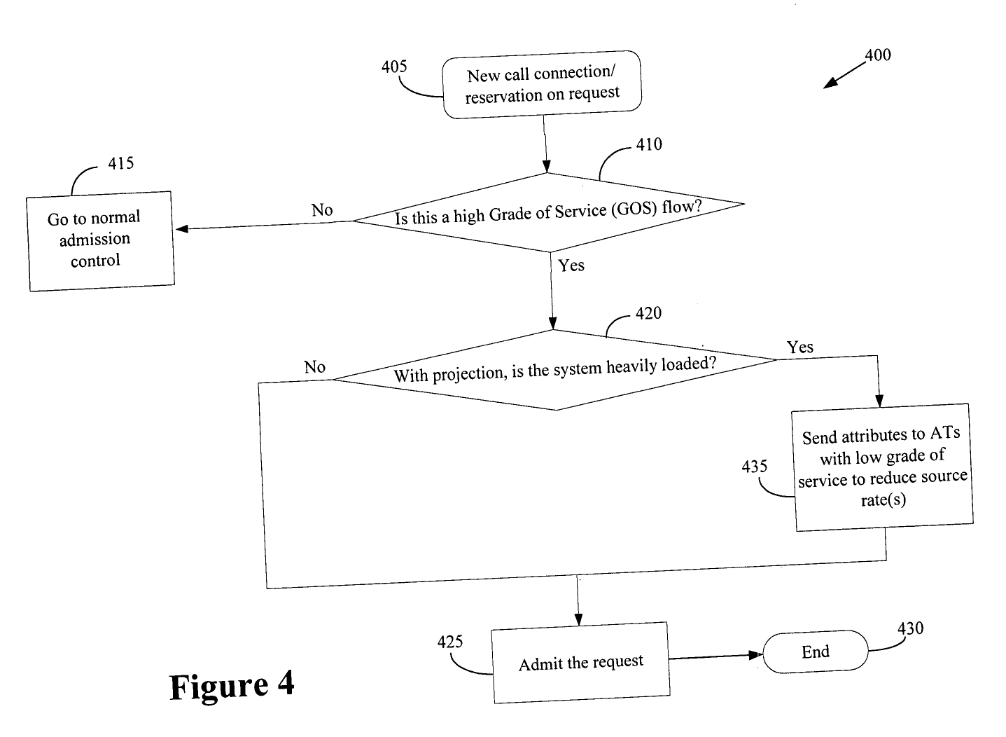

FIG. 4 conceptually illustrates one exemplary embodiment of a method 400 of handling call session requests based on a grade of service. In the illustrated embodiment, a request for a new call connection or a pending reservation may be received or accessed (at 405) by an access network. The access network may then determine (at 410) whether or not the call flow associated with the new call connection or the pending reservation is a high-grade of service flow or a low grade of service flow. If the call flow is a relatively low grade of service flow, then the new call connection or pending reservation may be handled (at 415) using normal admission control techniques.

The call flow may require a secured portion of the system resources that may be allocated to the high grade of service flow with its QOS ensured if the call flow is a relatively high grade of service flow. In one embodiment, the high grade of service flow may have to be admitted at the expense of the QOS of the low grade of service users or flows when the system is heavily loaded or even overloaded. The access network may therefore form a projection of the system loading assuming that the high grade of service flow is admitted. In one embodiment, determining the projected system loading may include determining a traffic loading associated with the new call connection or the pending reservation, as well as determining traffic loadings associated with one or more existing call flows and/or connections.

The access network may determine (at 420) whether or not the projected system loading is relatively large or relatively small. For example, the access network may compare the projected system loading to a threshold system loading. If the projected system loading is relatively small, e.g., the projected system loading is lower than the threshold system loading, then the new call connection or pending reservation may be admitted (at 425) and the method 400 may end (at 430). The access network may take one or more actions to attempt to reduce the projected system loading if the projected system loading is relatively large, e.g., the projected system loading is higher than the threshold system loading.

In the illustrated embodiment, the access network may send (at 435) information or attributes to access terminals having existing connections with the access network that operate at a relatively low grade of service. The information and/or attributes may indicate that the access terminals should reduce one or more source rates of applications, such as a vocoder rate, to reduce the overall system loading without dropping the low grade of service calls or flows. The new call connection or pending reservation with high grade of service, such as an emergency call and/or high premium services, may then be admitted (at 425) and the method 400 may end (at 430).

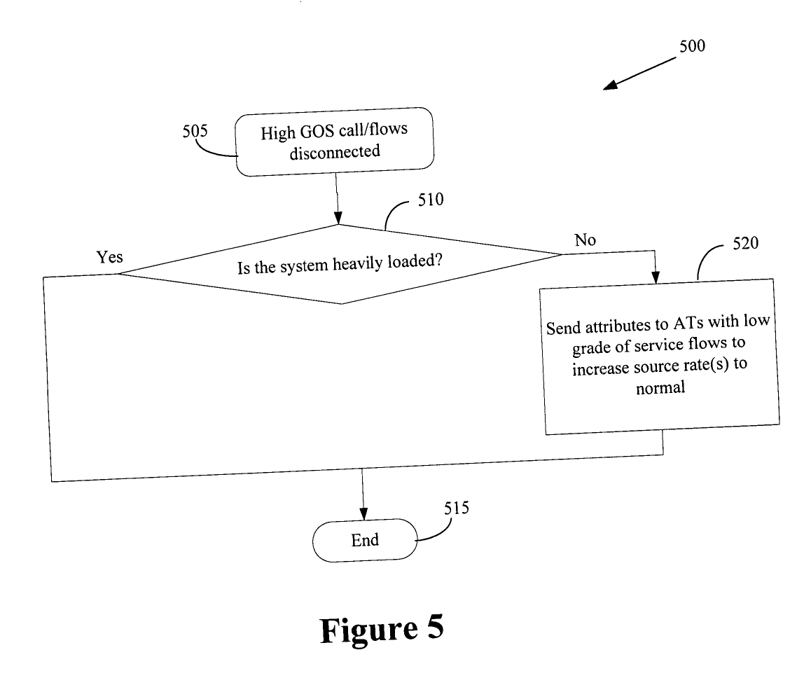

FIG. 5 conceptually illustrates one exemplary embodiment of a method 500 of modifying a source rate of an application, such as a vocoder. In the illustrated embodiment, one or more calls and/or call flows to provide a relatively high grade of service are disconnected (at 505) from the access network. The access network may then determine (at 510) whether or not the system remains heavily loaded after the relatively high grade of service calls or call flows are disconnected (at 505). If the system remains heavily loaded, then the access network may not modify the source rates associated with access terminals that still have active connections to the access network and the method 500 may end (at 515). However, if disconnecting (at 505) one or more calls and/or call flows reduces the system loading so that the system is no longer heavily loaded, e.g. the system loading is reduced below a threshold system loading, source rates of applications associated with active access terminals may be modified (at 520). In the illustrated embodiment, the access network sends (at 520) information or attributes indicating that the active access terminals having relatively low grade of service flows may increase their source rates of applications, e.g. to a normal source rate.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
accessing quality of service information associated with a voice application associated with an access terminal in response to receiving a call session request from the access terminal; and
determining whether to admit the requested call session based on the quality of service information associated with the voice application.

2. The method of claim 1, comprising receiving the call session request from the access terminal.

3. The method of claim 2, wherein receiving the call session request comprises receiving the call session request provided by the voice application.

4. The method of claim 3, wherein receiving the call session request provided by the voice application comprises receiving the quality of service information associated with the voice application.

5. The method of claim 4, wherein receiving the quality of service information comprises accessing a quality of service profile indicative of the quality of service information.

6. The method of claim 1, wherein accessing the quality of service information comprises accessing information indicative of at least one of a voice activity factor, an average source data rate associated with a vocoder, and a grade of service.

7. The method of claim 1, wherein accessing the quality of service information associated with the voice application comprises accessing quality of service information associated with at least one of a two-way full-duplex voice call, a two-way half-duplex voice call, a Push-to-Talk call, a Voice over Internet Protocol, a three-way call, a chat room, and a conference bridge call.

8. The method of claim 1, wherein accessing the quality of service information comprises accessing quality of service information associated with at least one of a forward link and a reverse link.

9. The method of claim 1, comprising negotiating a portion of the quality of service information associated with the voice application.

10. The method of claim 1, wherein determining whether to admit the requested call session comprises determining a projected system loading based on the quality of service information associated with the voice application.

11. The method of claim 10, wherein determining the projected system loading comprises determining a traffic loading associated with the requested call session based on the quality of service information associated with the voice application.

12. The method of claim 10, comprising determining whether at least one source rate of a voice application having a lower grade of service than the voice application associated with the access terminal is to be decreased in response to determining the system loading.

13. The method of claim 10, wherein determining the projected system loading comprises determining at least one traffic loading associated with at least one existing call session.

14. The method of claim 10, comprising determining a system loading in response to at least one existing call session being disconnected.

15. The method of claim 14, comprising providing information indicating that at least one source rate of a voice application associated with at least one access terminal may be increased in response to determining the system loading.

16. A method, comprising:
providing a call session request associated with a voice application;
providing quality of service information associated with the voice application; and
receiving information indicating whether the requested call session was admitted in response to providing the quality of service information associated with the voice application.

17. The method of claim 16, wherein providing the quality of service information comprises providing a quality of service profile indicative of the quality of service information.

18. The method of claim 16, wherein providing the quality of service information comprises providing information indicative of at least one of a voice activity factor, an average source data rate associated with a vocoder, and a grade of service.

19. The method of claim 16, wherein providing the quality of service information associated with the voice application comprises providing quality of service information associated with at least one of a two-way full-duplex voice call, a two-way half-duplex voice call, a Push-to-Talk call, a Voice over Internet Protocol call, a three-way call, a chat room, and a conference bridge call.

20. The method of claim 16, wherein providing the quality of service information comprises providing quality of service information associated with at least one of a forward link and a reverse link.

21. The method of claim 16, comprising negotiating a portion of the quality of service information associated with the voice application.

22. The method of claim 16, comprising receiving information indicating that at least one source rate associated with at least one voice application is to be increased in response to determining that a system loading has decreased in response to disconnection of an other call session.

23. The method of claim 16, wherein the voice application is associated with a grade of service, and comprising receiving information indicating that at least one source rate of a voice application having a lower grade of service than the voice application is to be decreased in response to determining the system loading.
